(19) United States
(12) Patent Application Publication
(10) Pub. No.: US 2026/0099314 A1
(43) Pub. Date: Apr. 9, 2026

(54) INTELLIGENT PAYLOAD PROCESSING FOR AUTOMOTIVE SYSTEMS, EDGE NETWORKS, AND MESH NETWORKS

(71) Applicant: Red Hat, Inc., Raleigh, NC (US)

(72) Inventors: Leigh Griffin, Waterford (IE); Arjay Hinek, Raleigh, NC (US)

(21) Appl. No.: 18/906,937

(22) Filed: Oct. 4, 2024

(51) Int. Cl. G06F 8/65; H04W 12/06

(52) U.S. Cl. CPC G06F 8/65; H04W 12/06

(57) ABSTRACT

A system and method of intelligent payload processing for computing network systems. The method includes receiving a request to perform one or more tasks on a computing device. The method includes acquiring environment data associated with a computing environment of the computing device. The method includes determining, by a processing device based on the environment data, a potential impact on the computing device associated with performing the one or more tasks. The method includes allowing or denying the computing device to perform the one or more tasks in response to determining the potential impact on the computing device associated with performing the one or more tasks.

### TECHNICAL FIELD

The present disclosure relates generally to software technology, and more particularly, to systems and methods of intelligent payload processing for computing network systems (e.g., automotive systems, edge networks, and/or mesh networks).

### BACKGROUND

The Internet of things (IoT) describes physical objects (or groups of such objects) with sensors, processing ability, software and other technologies that connect and exchange data with other devices and systems over the Internet or other communications networks. An edge device is a device that provides an entry point into enterprise or service provider core networks. A mesh network is a network in which nodes (e.g., IoT devices, edge devices) are linked together, branching off other devices or nodes. These networks are set up to efficiently route data between devices and clients. They help individuals and organizations provide a consistent connection throughout a physical space.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram depicting an example environment for intelligence payload processing in computing network systems, according to some embodiments;

FIG. 2A is a block diagram depicting an example node of the computing network system 102 in FIG. 1, according to some embodiments;

FIG. 2B is a block diagram depicting an example of the task management (TM) node of the environment in FIG. 1, according to some embodiments;

FIG. 2C is a block diagram depicting an example environment of a computing network system, according to some embodiments;

FIG. 3 is a flow diagram depicting a method of intelligently processing payloads in a computing network, according to some embodiments; and

FIG. 4 is a block diagram of an example computing device that may perform one or more of the operations described herein, in accordance with some embodiments.

### DETAILED DESCRIPTION

A challenge in a decentralized network, inherently mobile and hence environment aware devices, such as in Automotive or Edge computing, is the vulnerability that occurs when data (e.g., payloads) need to be processed and where the environmental conditions can present a challenge and/or an opportunity. The conventional approaches to validation predominantly rely on a cryptographic strategy, focusing on vulnerabilities in the classical sense, but the threat vector of the device stability and its environment is not considered. Traditional cryptographic approaches do not factor in contextual information (e.g., Vehicle-To-Everything (V2X context)) about the environment that could be considered a potential insight into the threat and hence our response. This is important due to the critical nature of Functional Safety (FuSa) certification and other legislative requirements for data integrity and protection. Thus, there is a long-felt but unsolved need to solve the problems of addressing the challenge of device security at this key operational juncture.

Aspects of the present disclosure address the above-noted and other deficiencies by providing a mechanism to intelligently process payloads in computing network systems (e.g., automotive systems, edge networks, and/or mesh networks). This may include managing the various update challenges that occur in a computing environment, where a payload for an update (e.g., firmware or a playbook for an Ansible® Automation Platform) to a critical system could be compromised. That is, the present disclosure could apply to messages, information requests, and/or other data centric operations. The present disclosure could also apply to Infrastructure as Code (IaC), such as Ansible®. IaC is method of managing and provisioning computing infrastructure through machine-readable definition files, rather than through physical hardware configuration or interactive configuration tools.

A mesh/edge network system may include a plurality of nodes (e.g., computing device, mesh device, edge device, Internet of things (IoT), and/or the like) that are geographically spaced apart, such that each node is assigned with a unique geolocation that differentiates the node from its neighboring nodes. That geolocation may include other relevant data sources from a number of clients in proximity to network capability and other environmental data (e.g., V2X sources).

The present disclosure introduces the concept of a trust table that includes rules governing operational interactions based on its current location, its current workload, and the environmental conditions. For example, if the payload was a software update, it could validate with other neighbor nodes that share the same version of the current software to validate if they also received it. This may see the node pause any attempt to process the payload until a level of consensus is reached among one or more of the neighbors. It may take a more permissive approach for a different payload or message classification and require higher/lower consensus or none at all. For example, if a keep alive message was sent, then the system may determine that it has a lower risk.

In some embodiments, a system may ascertain when a node should process certain message types depending on the workload it is currently running. This ensures that the system can flag certain services or capabilities to ensure that any risk derived message received will not cause a potential node failure. For example, the system would not advocate or allow a software update to take place if the only login service for the network is hosted on that device. Equally important is the current compute capabilities of the device and whether processing the message now would move the device into a zone where resource starvation may occur.

The outcomes of this may see the node not process the message if the environmental conditions are not favorable. For example, if the number of potential client devices is greater than a predefined threshold value (n); or if the network speed is lower than a different predefined threshold value (x); or if the message type requires certain contextual capabilities that are unfavorable, then the message (including its corresponding tasks) will not be processed due to a potential failure scenario that the system is predicting might occur. This matrix of these broad categories (e.g., there could be more, such as time since last message, or FuSa/Automotive Safety Integrity Level (ASIL) classification in the car) gives a layer of protection to decide on the optimal approach to handle an incoming payload that respects the challenges of the device in that point in time. It also allows for more intelligent usage of cryptographic protocols by making more contextual information available to help validate the integrity and intent of the payload it is about to decrypt.

Additional benefits of the embodiments of the present disclosure include creating a more resilient computing network, by preventing application updates on nodes of the computing network that could cause stability, interoperability, and/or vulnerability issues in the computing network. The embodiments also protect the computing network (including the nodes) from constant recertification tasks, which are not only costly from a monetary and computing resource perspective (e.g., computing, memory, bandwidth, etc.), but can also shut-down the critical services (e.g., automotive service) that were designed to protect users from dangers.

In an illustrative embodiment, a task management (TM) node of a computing network (e.g., a mesh network system, an edge network system) of nodes receives a request to perform one or more tasks (e.g., perform a software or firmware update, process one or more payloads, execute an applicate to provide a service, etc.) on a computing device. The TM node is configured to acquire environment data associated with a computing environment of the computing device. The environment data may be, for example, indicative of a current workload, a current resource usage, a current resource availability, a current resource health, a current resource version identifier, a number and type of current connections, whether the computing device is powered by a plug-in power supply or battery, and/or the like. The TM node is configured to determine, based on the environment data, a potential impact on the computing device associated with performing the one or more tasks. The TM node is configured to allow or deny the computing device to perform the one or more tasks in response to determining the potential impact on the computing device associated with performing the one or more tasks.

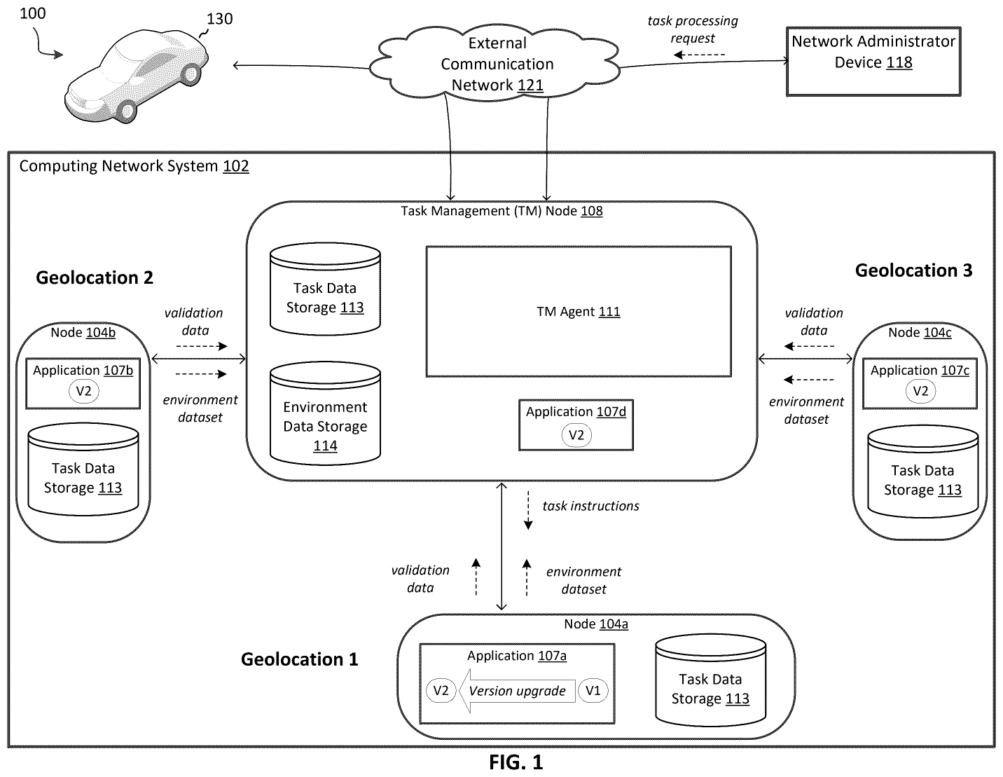

FIG. 1 is a block diagram depicting an example environment for intelligence payload processing in computing network systems, according to some embodiments. The environment 100 includes a computing network system 102, a network administrator device 118, and a vehicle 130 that are each coupled together through an external communication network 121. In some embodiments, the computing network system 102 may be configured to operate as an edge network system, an Internet of things (IoT) network system, and/or a mesh network system. The computing network system 102 includes a plurality of nodes 104 (e.g., nodes 104a, 104b, 104c) that are each communicatively coupled together via one or more communication networks (e.g., Bluetooth, wireless fidelity (Wi-Fi), cellular, etc.) of the computing network system 102. In some embodiments, any of the nodes 104 may be a vehicle like that of vehicle 130.

Each node 104 is configured to execute an application 107 of a particular version. Specifically, the node 104a is configured to execute an application 107a of a particular version (e.g., version 1 or V1), the node 104b is configured to execute an application 107b of a particular version (e.g., version 2 or V2), and the node 104c is configured to execute an application 107c of a particular version (e.g., version 2 or V2). One or more of the nodes 104 may execute the same version of the application 107 or different versions of the same application 107.

An application 107 may be any type of software application that provides any type of service (e.g., a network service, a computing service, a security service, etc.) for the node 104, a user of the node 104, and/or a computing device (e.g., vehicle 130) that is outside of the computing network system 102. For example, the application 107b executing on the node 104b may be an antivirus application that protects the computing resources of the node 104b from malicious activity, such as phishing attacks, viruses, malware, and ransomware. As another example, the application 107c executing on the node 104c may be a navigation application that provides navigation services (e.g., Global Positioning System (GPS) coordinates) to the vehicle 130. Different versions of the same application 107 provide different types of services. For example, a first version (e.g., V1) of application 107a may provide a low-bandwidth networking service for node 104a, but after upgrading application 107a to a second version (e.g., V2), the application 107a may provide a high-bandwidth networking service for node 104a. In some embodiments, the application 107 may be a functional safety application that provides a critical service for the node 104, a user of the node 104, and/or a computing device that is outside of the computing network system 102. A critical service may be a service that impacts a safety of a user that is associated with a node 104. For example, the application 107 may be configured to provide a service (e.g., Fusa) to the vehicle 130 to control the movement (e.g., acceleration, velocity, breaking, and/or steering) of the vehicle 130.

The computing network system 102 includes a task management (TM) node 108 (sometimes referred to as, control node), which is a node 104 that is further configured with additional administrative functionality for controlling and/or managing the other nodes 104 in the computing network system 102. The TM node 108 is communicably coupled to one or more computing devices (e.g., network administrator device 118, vehicle 130, etc.) that are outside and not a member of the computing network system 102 via an external communication network 121. In some embodiments, the external communication network 121 may be any of the communication networks of the computing network system 102.

The network administrator device 118 sends, to the TM node 108, a request (shown in FIG. 1 as task processing request) for one or more of the nodes 104 to perform one or more tasks on more or more of the nodes 104. The TM node 108 may decide to forward the request to one or more of the nodes 104 based on information included in the request. In some embodiments, the request may be for a particular node 104 to perform a software update (e.g., an upgrade from version 1 to version 2) and/or a firmware update. In some embodiments, the request may be for a particular node 104 to process a payload (e.g., data) that is locally stored on the particular node 104 or stored remotely from the particular node 104.

The TM node 108 includes a TM agent 111, a task data storage 113, and an environment data storage 114. In some embodiments, the TM node a08 may execute an application 107 (e.g., application 107d).

Each of the nodes 104 periodically (e.g., daily, weekly, etc.), or based on a triggering event (e.g., upon determining a change to the environment dataset), send their respective environment dataset to the TM agent 111, which in turn, stores the environment datasets in the environment data storage 114.

An environment dataset associated with a particular node 104 (e.g., node 104a) may indicate a current usage of a resource of the node 104, a current availability of the resource of the node 104, an execution time of the resource of the node 104, a current resource version identifier (ID), and/or a current health of the resource of the node 104. The current health of the resource indicates a degree in which the resource has degraded (if at all) over time. For example, a brand-new battery that provides power to an electronic device would discharge at a slower rate than an older battery that provides power to a similar electronic device. A resource may be any type of computing resource of a node 104 including, for example, one or more processors (e.g., central processing units (CPUs)), a memory, a cache, a data storage (e.g., a hard drive), a network adapter, a battery, an operating system, and the like.

In some embodiments, an environment dataset associated with a particular node 104 may indicate whether the particular node 104 is communicatively connected to an insecure communication network (e.g., public Wi-Fi) and/or an insecure device. In some embodiments, an environment dataset associated with a particular node 104 may indicate whether the particular node 104 hosts a sole login service associated with a computing network.

The TM agent 111 is configured to generate (e.g., calculate) an impact profile for each node 104 and based on that node's 104 corresponding environment dataset. instead of receiving the impact profiles from the nodes 104 themselves. An impact profile indicates a potential impact on one or more resources of the node 104 that might occur as a result of the node 104 the performing the one or more tasks indicated in the request. For example, an impact profile may indicate that a performance of a CPU of the node 104a was degraded (or in other embodiments, improved) by 10% after the node 104a carry out the task of upgrading its application 107a from version 1 to version 2. As another example, an impact profile may indicate that a discharge rate of a battery of the node 104a was degraded (or in other embodiments, improved) by 2% after the application 107a was upgraded from version 1 to version 2. As another example, an impact profile also indicates one or more execution times of each version of an application 107. As another example, an impact profile may also indicate that the application 107a was upgraded from one version (e.g., version 1) to another (e.g., version 2) at some time in the past, for example, 1 hour ago, 1 day ago, 1 week ago, etc. As another example, an impact profile may indicate that a performance of a CPU of the node 104a was degraded (or in other embodiments, improved) by 40% after the node 104a carry out the task of processing one or more payloads.

A potential impact to a computing resource of a node 104 may be an impact that the TM agent 111 foresees could possibly degrade a performance (e.g., an efficiency, a power consumption, a processing speed, a computing accuracy, a battery discharging/charging rate, etc.) of the computing resource of the node 104 or an ability for the computing resource to interoperate with other computing resources on the node 104 if the application 107 on the node 104 were upgraded from one version (e.g., V1) of the application 107 to another version (e.g., V2) of the application 107, or downgraded from one version (e.g., V2) of the application 107 to another version (e.g., V1) of the application 107.

A potential impact may be one that degrades a performance, interoperability, and/or a vulnerability of a computing resource of a node 104. For example, a performance (e.g., speed, accuracy, etc.) of the memory of node 104a might be degraded by 10% after the application 107a is upgraded from version 1 to version 2. The version upgrade might also degrade the interoperability between the memory and the processor by degrading the signal quality (e.g., smaller amplitude, more jitter, etc.) of the memory's data bus that is coupled to the processor. The version upgrade might also degrade a security feature of the application 107a to cause the computing resource to be exposed to more malicious attacks. Alternatively, a potential impact may be one that improves a performance or interoperability of a computing resource of a node 104. For example, a performance of the memory of node 104a might be improved by 10% after the application 107a is upgraded from version 1 to version 2. The version upgrade might also improve the interoperability between the memory and the processor by improving the signal quality (e.g., larger amplitude, less jitter, etc.) of the memory's data bus. The version upgrade might also improve a security feature of the application 107a to cause the computing resource to be exposed to less malicious attacks.

The TM agent 111 is configured to generate, based on the potential impact, message classification, environment data, and/or validation data a set of task instructions to send to one or more of the nodes. The task instructions either indicate for the one or more nodes to perform the one or more tasks included in the task processing request or to not perform the one or more tasks.

A communication network (e.g., external communication network 121, any of the communication networks of the computing network system 102) may be a public network (e.g., the internet), a private network (e.g., a local area network (LAN) or wide area network (WAN)), or a combination thereof. In some embodiments, a communication network may include a wired or a wireless infrastructure, which may be provided by one or more wireless communications systems, such as wireless fidelity (Wi-Fi) connectivity to the external network and/or a wireless carrier system that can be implemented using various data processing equipment, communication towers (e.g., cell towers), etc. The external network may carry communications (e.g., data, message, packets, frames, etc.) between any other the computing device.

A node 104, the TM node 108, and a network administrator device 118 may each be any suitable type of computing device or machine that has a processing device, for example, a server computer (e.g., an application server, a catalog server, a communications server, a computing server, a database server, a file server, a game server, a mail server, a media server, a proxy server, a virtual server, a web server), a desktop computer, a laptop computer, a tablet computer, a mobile device, a smartphone, a set-top box, a graphics processing unit (GPU), etc. In some examples, a computing device may include a single machine or may include multiple interconnected machines (e.g., multiple servers configured in a cluster). The vehicle 130 may include a computing device of any type, as discussed herein.

In some embodiments, the node 104, the TM node 108, and the network administrator device 118 may each be a wearable device (e.g., smartwatch, smart clothing, smart glasses, smart jewelry, wearable camera, wireless earbuds, fitness tracker, blood pressure monitor, heart rate monitor, etc.) or an implantable device (e.g., insulin pump, cochlear device, pacemaker, brain simulator, etc.).

Still referring to FIG. 1, the TM node 108 receives a request to perform one or more tasks (e.g., a software or firmware upgrade, process one or more payloads, etc.) on a computing device (e.g., node 104a). The TM node 108 is configured to acquire environment data (e.g., current workload, current resource usage, current resource availability, current resource health, current resource version identifier, number of current connection types, battery health, type of power source, etc.) associated with a computing environment of the computing device. The TM node 108 is configured to determine, based on the environment data, a potential impact on the computing device associated with performing the one or more tasks. The TM node 108 is configured to allow or deny the computing device to perform the one or more tasks in response to determining the potential impact on the computing device associated with performing the one or more tasks.

Although FIG. 1 shows only a select number of computing devices (e.g., nodes 104, TM node 108, network administrator device 118), the environment 100 may include any number of computing devices that are interconnected in any arrangement to facilitate the exchange of data between the computing devices. The environment may also include any number of vehicles 130.

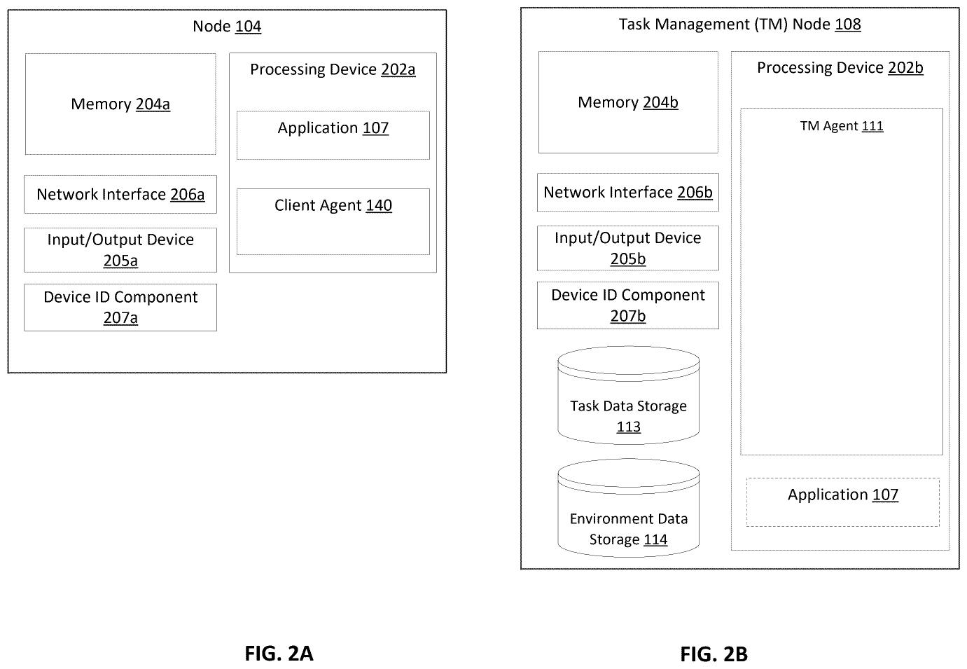

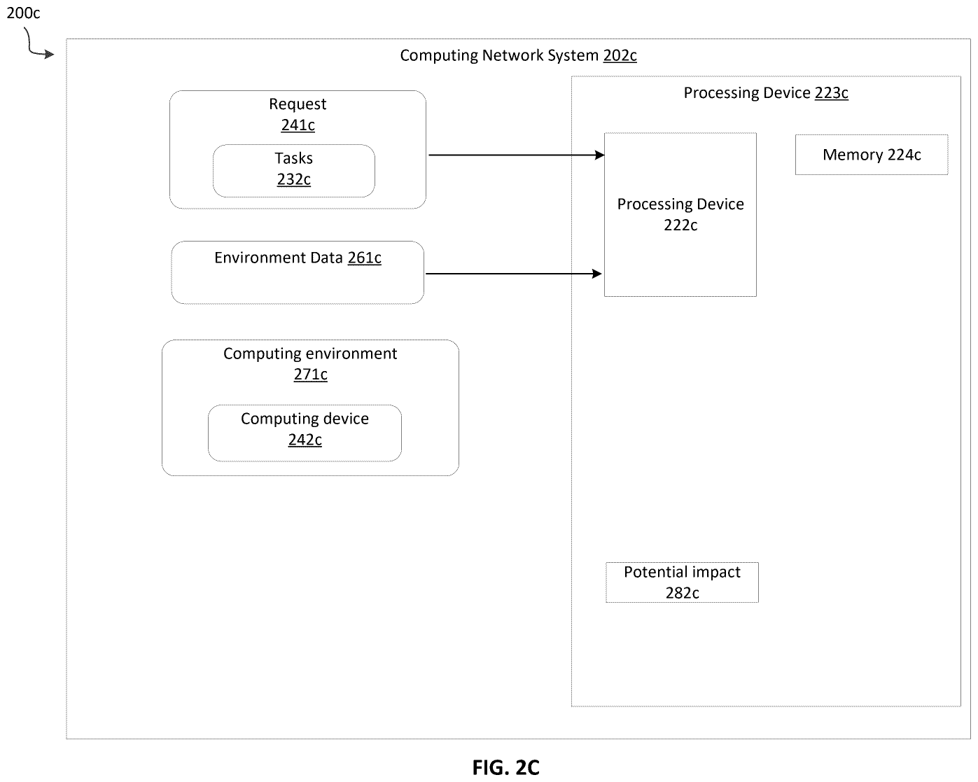

FIG. 2A is a block diagram depicting an example node 104 of the computing network system 102 in FIG. 1, according to some embodiments. While various devices, interfaces, and logic with particular functionality are shown, it should be understood that the one or more nodes 104 (e.g., nodes 104a-c) of the computing network system 102 each include any number of devices and/or components, interfaces, and logic for facilitating the functions described herein. For example, the activities of multiple devices may be combined as a single device and implemented on a same processing device (e.g., processing device 202a), as additional devices and/or components with additional functionality are included.

The node 104 includes a processing device 202a (e.g., general purpose processor, a PLD, etc.), which may be composed of one or more processors, and a memory 204a (e.g., synchronous dynamic random-access memory (DRAM), read-only memory (ROM)), which may communicate with each other via a bus (not shown).

The processing device 202a may be provided by one or more general-purpose processing devices such as a microprocessor, central processing unit, or the like. In some embodiments, processing device 202a may include a complex instruction set computing (CISC) microprocessor, reduced instruction set computing (RISC) microprocessor, very long instruction word (VLIW) microprocessor, or a processor implementing other instruction sets or processors implementing a combination of instruction sets. In some embodiments, the processing device 202a may include one or more special-purpose processing devices such as an application specific integrated circuit (ASIC), a field programmable gate array (FPGA), a digital signal processor (DSP), network processor, or the like. The processing device 202a may be configured to execute the operations described herein, in accordance with one or more aspects of the present disclosure, for performing the operations and steps discussed herein.

The memory 204a (e.g., Random Access Memory (RAM), Read-Only Memory (ROM), Non-volatile RAM (NVRAM), Flash Memory, hard disk storage, optical media, etc.) of processing device 202a stores data and/or computer instructions/code for facilitating at least some of the various processes described herein. The memory 204a includes tangible, non-transient volatile memory, or non-volatile memory. The memory 204a stores programming logic (e.g., instructions/code) that, when executed by the processing device 202a, controls the operations of the node 104. In some embodiments, the processing device 202a and the memory 204a form various processing devices and/or circuits described with respect to the node 104. The instructions include code from any suitable computer programming language such as, but not limited to, C, C++, C #, Java, JavaScript, VBScript, Perl, HTML, XML, Python, TCL, and Basic.

The processing device 202a executes the application 107 of a particular version. The application 107 may be any type of software application that provides any type of service (e.g., a network service, a computing service, a security service, etc.) for the node 104, a user of the node 104, and/or a computing device (e.g., vehicle 130) that is outside of the computing network system 102. Different versions of the same application 107 provide different types of services. In some embodiments, the application 107 may be a functional safety application that provides a critical service for the node 104, a user of the node 104, and/or a computing device that is outside of the computing network system 102. A critical service may be a service that impacts a safety of a user that is associated with a node 104. For example, the application 107 may be configured to provide a service to the vehicle 130 to control the movement (e.g., acceleration, velocity, breaking, and/or steering) of the vehicle 130.

The processing device 202a executes a client agent 140 that is configured to periodically send its environmental data to the TM node 108, or according to the technique describe herein with regard to other embodiments of the present disclosure. The client agent 140 may include information in the environment data that describes the state/condition of its local resources by periodically capturing resource data from its computing resources (e.g., processing device 202a, memory 204a, etc.) immediately prior sending the environment data to the TM node 108 to ensure that the TM node 108 receives the most-current environment data.

The client agent 140 may be configured to receive task instructions from the TM 108, which cause the client agent 140 to carry out the one or more tasks (e.g., process one or more payloads, perform a software or firmware update, and/or the like.) in the task instructions.

The node 104 includes a network interface 206a configured to establish a communication session with a computing device for sending and receiving data over a communication network to the computing device. Accordingly, the network interface 206a includes a cellular transceiver (supporting cellular standards), a local wireless network transceiver (supporting 802.11X, ZigBee, Bluetooth, Wi-Fi, or the like), a wired network interface, a combination thereof (e.g., both a cellular transceiver and a Bluetooth transceiver), and/or the like. In some embodiments, the node 104 includes a plurality of network interfaces 206a of different types, allowing for connections to a variety of networks, such as local area networks (public or private) or wide area networks including the Internet, via different sub-networks.

The node 104 includes an input/output device 205a configured to receive user input from and provide information to a user. In this regard, the input/output device 205a is structured to exchange data, communications, instructions, etc. with an input/output component of the node 104. Accordingly, input/output device 205a may be any electronic device that conveys data to a user by generating sensory information (e.g., a visualization on a display, one or more sounds, tactile feedback, etc.) and/or converts received sensory information from a user into electronic signals (e.g., a keyboard, a mouse, a pointing device, a touch screen display, a microphone, etc.). The one or more user interfaces may be internal to the housing of the node 104, such as a built-in display, touch screen, microphone, etc., or external to the housing of the node 104, such as a monitor connected to the node 104, a speaker connected to the node 104, etc., according to various embodiments. In some embodiments, the node 104 includes communication circuitry for facilitating the exchange of data, values, messages, and the like between the input/output device 205a and the components of the node 104. In some embodiments, the input/output device 205a includes machine-readable media for facilitating the exchange of information between the input/output device 205a and the components of the node 104. In still another embodiment, the input/output device 205a includes any combination of hardware components (e.g., a touchscreen), communication circuitry, and machine-readable media.

The node 104 includes a device identification component 207a (shown in FIG. 2A as device ID component 207a) configured to generate and/or manage a device identifier (sometimes referred to as, “node ID”) associated with the node 104. The device identifier may include any type and form of identification used to distinguish the node 104 from other computing devices. In some embodiments, to preserve privacy, the device identifier may be cryptographically generated, encrypted, or otherwise obfuscated by any device and/or component of node 104. In some embodiments, the node 104 may include the device identifier in any communication (e.g., public encrypted message, private encrypted message, etc.) that the node 104 sends to a computing device.

The node 104 includes a bus (not shown), such as an address/data bus or other communication mechanism for communicating information, which interconnects the devices and/or components of node 104, such as processing device 202a, network interface 206a, input/output device 205a, and/or device ID component 207a.

In some embodiments, some or all the devices and/or components of node 104 may be implemented with the processing device 202a. For example, the node 104 may be implemented as a software application stored within the memory 204a and executed by the processing device 202a. Accordingly, such embodiment can be implemented with minimal or no additional hardware costs. In some embodiments, any of these above-recited devices and/or components rely on dedicated hardware specifically configured for performing operations of the devices and/or components.

FIG. 2B is a block diagram depicting an example of the task management (TM) node 108 of the environment in FIG. 1, according to some embodiments. While various devices, interfaces, and logic with particular functionality are shown, it should be understood that the TM node 108 includes any number of devices and/or components, interfaces, and logic for facilitating the functions described herein. For example, the activities of multiple devices may be combined as a single device and implemented on a same processing device (e.g., processing device 202b), as additional devices and/or components with additional functionality are included.

The TM node 108 includes the task data storage 113 and the environment data storage 114.

The TM node 108 includes a processing device 202b (e.g., general purpose processor, a PLD, etc.), which may be composed of one or more processors, and a memory 204b (e.g., synchronous dynamic random-access memory (DRAM), read-only memory (ROM)), which may communicate with each other via a bus (not shown). The processing device 202b includes identical or nearly identical functionality as processing device 202a in FIG. 2a, but with respect to devices and/or components of the TM node 108 instead of devices and/or components of the node 104.

The memory 204b of processing device 202b stores data and/or computer instructions/code for facilitating at least some of the various processes described herein. The memory 204b includes identical or nearly identical functionality as memory 204a in FIG. 2A, but with respect to devices and/or components of the TM node 108 instead of devices and/or components of the node 104.

The processing device 202a of the TM node 108 may execute an application 107 of a particular version. The application 107 may be configured to provide a service directly to the TM node 108 instead of the other nodes in the computing network system. For example, the TM node 108 may be included in or mounted onto a vehicle, where the application 107 executing on the TM node 108 controls the movement (e.g., acceleration, velocity, breaking, and/or steering) of the vehicle or provides navigational directions for the vehicle.

The processing device 202b executes a TM agent 111. The TM agent 111 may be configured to receive a request to perform one or more tasks on a computing device. The TM agent 111 may be configured to acquire environment data associated with a computing environment of the computing device. The TM agent 111 may be configured to determine, based on the environment data, a potential impact on the computing device associated with performing the one or more tasks. The TM agent 111 may be configured to allow or deny the computing device to perform the one or more tasks in response to determining the potential impact on the computing device associated with performing the one or more tasks.

In some embodiments, the one or more tasks correspond to at least one of: installing a software upgrade or a firmware upgrade on the computing device; processing a payload on the computing device; or validating a payload request on the computing device.

In some embodiments, the computing device corresponds to a mesh node in a mesh network of nodes. The TM agent 111 may be configured to acquire information indicating whether one or more neighboring nodes of the mesh node installed the software upgrade or the firmware update. The TM agent 111 may be configured to authenticate the request by determining that the one or more neighboring nodes installed the software upgrade or the firmware upgrade. The TM agent 111 may be configured to allow the computing device to perform the one or more tasks is further in response to authenticating the request.

The TM agent 111 may be configured to authenticate the request by determining a classification for the request; determining a level of consensus based on the classification; and determining that the level of consensus is reached among a plurality of neighboring nodes of the mesh network of nodes based on validation data (as shown in FIG. 1) received from each of the nodes. The validation data indicates whether the node decided to perform the task (e.g., system upgrade) or decide against performing the task.

The TM agent 111 may be configured to determine, based on the environment data, the potential impact on the computing device associated with performing the one or more tasks by determining that the computing device is coupled to at least one of an insecure communication network or an insecure device; and determining to deny the computing device from performing the one or more tasks.

The TM agent 111 may be configured to determine, based on the environment data, the potential impact on the computing device associated with performing the one or more tasks by determining that the computing device hosts a sole login service associated with a computing network; and determining to deny the computing device from performing the one or more tasks.

The TM agent 111 may be configured to determine, based on the environment data, the potential impact on the computing device associated with performing the one or more tasks by determining an inability for the computing device to maintain a quality of service (QoS) associated with a particular service according to a predefined threshold; and determining to deny the computing device from performing the one or more tasks.

The TM agent 111 may be configured to deny the computing device to perform the one or more tasks by identifying, based on the environment data, a first time period in which the potential impact on the computing device is above a predefined threshold value; identifying, based on the environment data, a second time period in which the potential impact on the computing device is below the predefined threshold value; denying the computing device to perform the one or more tasks during the first time period; and allowing the computing device to perform the one or more tasks during the second time period.

In some embodiments, the particular service corresponds to a Functional Safety (FuSa) service in an automotive system and the computing device corresponds to the processing device.

The TM agent 111 may be configured to identify, based on the environment data, a time period during which the computing device is powered by a plug-in power supply; and instruct the computing device to perform a second task during the time period.

As discussed above, the processing device 202b of the TM node 108 may also execute an application 107 of a particular version. In this embodiment, the TM agent 111 may be configured to determine that a version upgrade is available for the application 107 that is executing on the TM node 108, and in response, may determine whether to upgrade the application 107 executing on the TM node 108.

The TM node 108 includes a network interface 206b configured to establish a communication session with a computing device for sending and receiving data over a network to the computing device. Accordingly, the network interface 206b includes identical or nearly identical functionality as network interface 206a in FIG. 2A, but with respect to devices and/or components of the TM node 108 instead of devices and/or components of the node 104.

The TM node 108 includes an input/output device 205b configured to receive user input from and provide information to a user. In this regard, the input/output device 205b is structured to exchange data, communications, instructions, etc. with an input/output component of the TM node 108. The input/output device 205b includes identical or nearly identical functionality as input/output device 205a in FIG. 2A, but with respect to devices and/or components of the TM node 108 instead of devices and/or components of the node 104.

The TM node 108 includes a device identification component 207b (shown in FIG. 2B as device ID component 207b) configured to generate and/or manage a device identifier associated with the TM node 108. The device ID component 207b includes identical or nearly identical functionality as device ID component 207a in FIG. 2A, but with respect to devices and/or components of the TM node 108 instead of devices and/or components of the node 104.

The TM node 108 includes a bus (not shown), such as an address/data bus or other communication mechanism for communicating information, which interconnects the devices and/or components of the TM node 108, such as processing device 202b, network interface 206b, input/output device 205b, and/or device ID component 207b.

In some embodiments, some or all the devices and/or components of TM node 108 may be implemented with the processing device 202b. For example, the TM node 108 may be implemented as a software application stored within the memory 204b and executed by the processing device 202b. Accordingly, such embodiment can be implemented with minimal or no additional hardware costs. In some embodiments, any of these above-recited devices and/or components rely on dedicated hardware specifically configured for performing operations of the devices and/or components.

FIG. 2C is a block diagram depicting an example environment of a computing network system, according to some embodiments. A computing network system 202c (e.g., computing network system 102 in FIG. 1) may include a processing device 223c and memory 224c coupled to the processing device 223c. The processing device 223 receives a request 241c to perform one or more tasks 232c on a computing device 242c. The processing device 223c may acquire environment data 261c associated with a computing environment 271c of the computing device 242c. The processing device 223c may determine, based on the environment data 261c, a potential impact 282c on the computing device 242c associated with performing the one or more tasks 232c. The processing device 223c may allow or deny the computing device 242c to perform the one or more tasks 232c in response to determining the potential impact 282c on the computing device 242c associated with performing the one or more tasks 232c.

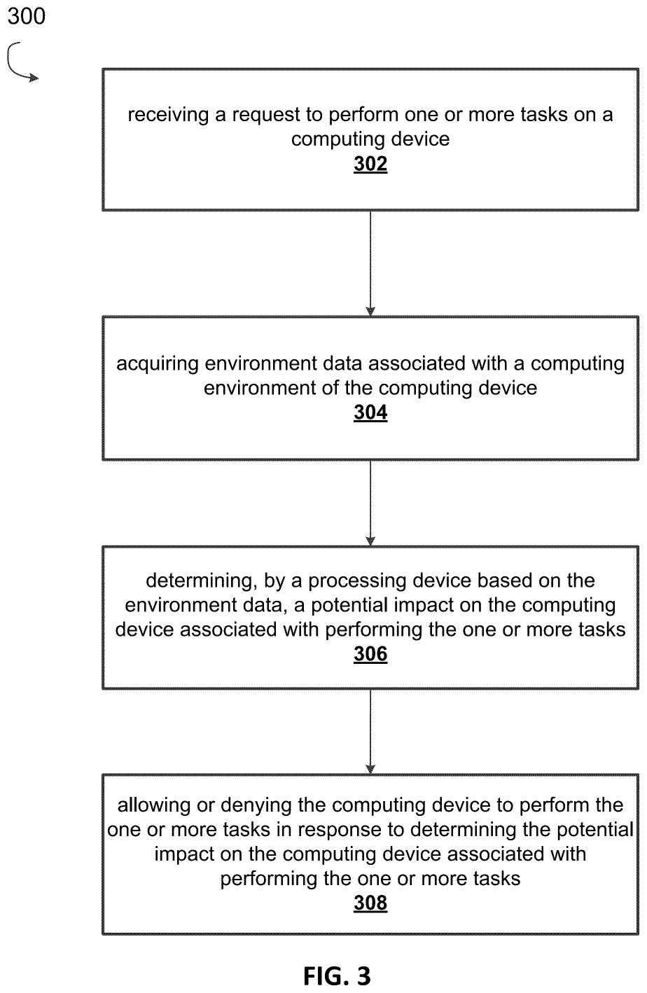

FIG. 3 is a flow diagram depicting a method of intelligently processing payloads in a computing network, according to some embodiments. Method 300 may be performed by processing logic that may include hardware (e.g., circuitry, dedicated logic, programmable logic, a processor, a processing device, a central processing unit (CPU), a system-on-chip (SoC), etc.), software (e.g., instructions and/or an application that is running/executing on a processing device), firmware (e.g., microcode), or a combination thereof. In some embodiments, method 300 may be performed by a TM node, such as TM node 108 in FIG. 1. In some embodiments, method 300 may be performed by one or more nodes, such as nodes 104 in FIG. 1. In some embodiments, method 300 may be performed by a computing network system, such as computing network system 102 in FIG. 1.

With reference to FIG. 3, method 300 illustrates example functions used by various embodiments. Although specific function blocks (“blocks”) are disclosed in method 300, such blocks are examples. That is, embodiments are well suited to performing various other blocks or variations of the blocks recited in method 300. It is appreciated that the blocks in method 300 may be performed in an order different than presented, and that not all of the blocks in method 300 may be performed.

As shown in FIG. 3, the method 300 includes the block 302 of receiving a request to perform one or more tasks on a computing device. The method 300 includes the block 304 of acquiring environment data associated with a computing environment of the computing device. The method 300 includes the block 306 of determining, by a processing device based on the environment data, a potential impact on the computing device associated with performing the one or more tasks. The method of 300 includes the block 308 of allowing or denying the computing device to perform the one or more tasks in response to determining the potential impact on the computing device associated with performing the one or more tasks.

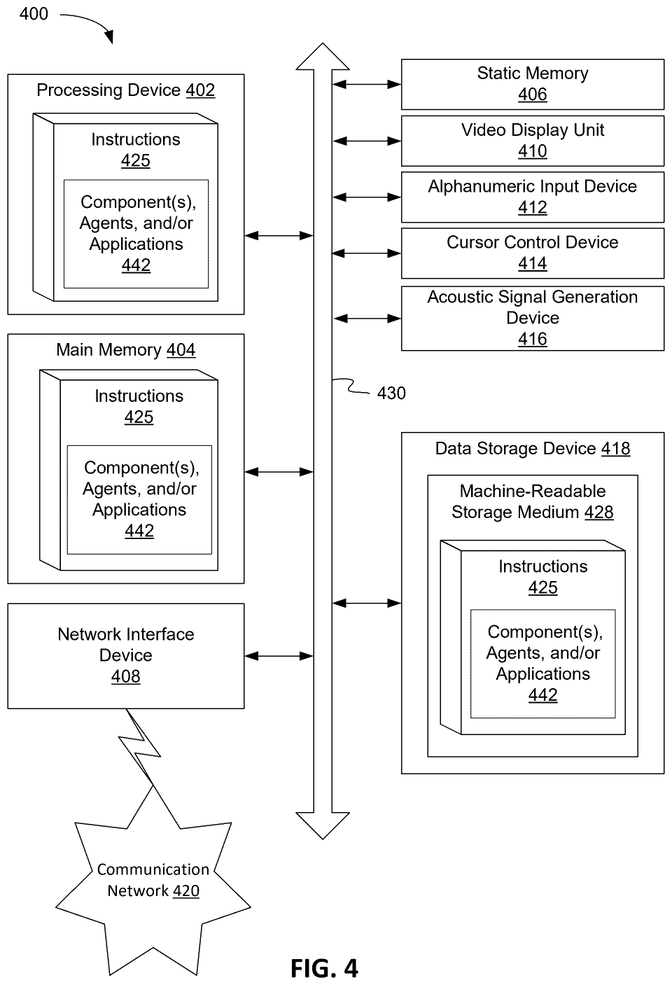

FIG. 4 is a block diagram of an example computing device 400 that may perform one or more of the operations described herein, in accordance with some embodiments. Computing device 400 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 400 may include a processing device (e.g., a general-purpose processor, a PLD, etc.) 402, a main memory 404 (e.g., synchronous dynamic random-access memory (DRAM), read-only memory (ROM)), a static memory 406 (e.g., flash memory and a data storage device 418), which may communicate with each other via a bus 430.

Processing device 402 may be provided by one or more general-purpose processing devices such as a microprocessor, central processing unit, or the like. In an illustrative example, processing device 402 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 402 may also include one or more special-purpose processing devices such as an application specific integrated circuit (ASIC), a field programmable gate array (FPGA), a digital signal processor (DSP), network processor, or the like. The processing device 402 may be configured to execute the operations described herein, in accordance with one or more aspects of the present disclosure, for performing the operations and steps discussed herein.

Computing device 400 may further include a network interface device 408 which may communicate with a communication network 420. The computing device 400 also may include a video display unit 410 (e.g., a liquid crystal display (LCD) or a cathode ray tube (CRT)), an alphanumeric input device 412 (e.g., a keyboard), a cursor control device 414 (e.g., a mouse) and an acoustic signal generation device 416 (e.g., a speaker). In one embodiment, video display unit 410, alphanumeric input device 412, and cursor control device 414 may be combined into a single component or device (e.g., an LCD touch screen).

Data storage device 418 may include a computer-readable storage medium 428 on which may be stored one or more sets of instructions 425 that may include instructions for one or more components, agents, and/or applications 442 (e.g., TM agent 111 in FIG. 1) for carrying out the operations described herein, in accordance with one or more aspects of the present disclosure. Instructions 425 may also reside, completely or at least partially, within main memory 404 and/or within processing device 402 during execution thereof by computing device 400, main memory 404 and processing device 402 also constituting computer-readable media. The instructions 425 may further be transmitted or received over a communication network 420 via network interface device 408.

While computer-readable storage medium 428 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “receiving,” “acquiring,” “determining,” “denying” “allowing,” “installing,” “processing,” “validating,” “authenticating,” “identifying,” “instructing” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112(f), for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method, comprising:
receiving a request to perform one or more tasks on a computing device;
acquiring environment data associated with a computing environment of the computing device;
determining, by a processing device based on the environment data, a potential impact on the computing device associated with performing the one or more tasks; and
allowing or denying the computing device to perform the one or more tasks in response to determining the potential impact on the computing device associated with performing the one or more tasks.

2. The method of claim 1, wherein the one or more tasks correspond to at least one of:
installing a software upgrade or a firmware upgrade on the computing device;
processing a payload on the computing device; or
validating a payload request on the computing device.

3. The method of claim 2, wherein the computing device corresponds to a mesh node in a mesh network of nodes, and further comprising:
acquiring information indicating whether one or more neighboring nodes of the mesh node installed the software upgrade or the firmware update;
authenticating the request by determining that the one or more neighboring nodes installed the software upgrade or the firmware upgrade; and
wherein allowing the computing device to perform the one or more tasks is further in response to authenticating the request.

4. The method of claim 3, wherein authenticating the request further comprises:
determining a classification for the request;
determining a level of consensus based on the classification; and
determining that the level of consensus is reached among a plurality of neighboring nodes of the mesh network of nodes.

5. The method of claim 1, wherein determining by the processing device based on the environment data, the potential impact on the computing device associated with performing the one or more tasks further comprises:
determining that the computing device is coupled to at least one of an insecure communication network or an insecure device; and
determining to deny the computing device from performing the one or more tasks.

6. The method of claim 1, wherein determining by the processing device based on the environment data, the potential impact on the computing device associated with performing the one or more tasks further comprises:
determining that the computing device hosts a sole login service associated with a computing network; and
determining to deny the computing device from performing the one or more tasks.

7. The method of claim 1, wherein determining by the processing device based on the environment data, the potential impact on the computing device associated with performing the one or more tasks further comprises:
determining an inability for the computing device to maintain a quality of service (QoS) associated with a particular service according to a predefined threshold; and
determining to deny the computing device from performing the one or more tasks.

8. The method of claim 1, wherein denying the computing device to perform the one or more tasks further comprises:
identifying, based on the environment data, a first time period in which the potential impact on the computing device is above a predefined threshold value;
identifying, based on the environment data, a second time period in which the potential impact on the computing device is below the predefined threshold value;
denying the computing device to perform the one or more tasks during the first time period; and
allowing the computing device to perform the one or more tasks during the second time period.

9. The method of claim 7, wherein the particular service corresponds to a Functional Safety (FuSa) service in an automotive system and the computing device corresponds to the processing device.

10. The method of claim 1, further comprising:
identifying, based on the environment data, a time period during which the computing device is powered by a plug-in power supply; and
instructing the computing device to perform a second task during the time period.

11. A system, comprising:
a memory; and
a processing device, operatively coupled to the memory, to:
receive a request to perform one or more tasks on a computing device;
acquire environment data associated with a computing environment of the computing device;
determine, based on the environment data, a potential impact on the computing device associated with performing the one or more tasks; and
allow or deny the computing device to perform the one or more tasks in response to determining the potential impact on the computing device associated with performing the one or more tasks.

12. The system of claim 11, wherein the one or more tasks correspond to at least one of:
installing a software upgrade or a firmware upgrade on the computing device;
processing a payload on the computing device; or
validating a payload request on the computing device.

13. The system of claim 12, wherein the computing device corresponds to a mesh node in a mesh network of nodes, and wherein the processing device is further to:
acquire information indicating whether one or more neighboring nodes of the mesh node installed the software upgrade or the firmware update;
authenticate the request by determining that the one or more neighboring nodes installed the software upgrade or the firmware upgrade; and
wherein to allow the computing device to perform the one or more tasks is further in response to authenticating the request.

14. The system of claim 13, wherein to authenticate the request, the processing device is further to:
determine a classification for the request;
determine a level of consensus based on the classification; and
determine that the level of consensus is reached among a plurality of neighboring nodes of the mesh network of nodes.

15. The system of claim 11, wherein to determine, based on the environment data, the potential impact on the computing device associated with performing the one or more tasks, the processing device is further to:
determine that the computing device is coupled to at least one of an insecure communication network or an insecure device; and
determine to deny the computing device from performing the one or more tasks.

16. The system of claim 11, wherein to determine, based on the environment data, the potential impact on the computing device associated with performing the one or more tasks, the processing device is further to:
determine that the computing device hosts a sole login service associated with a computing network; and
determine to deny the computing device from performing the one or more tasks.

17. The system of claim 11, wherein to determine, based on the environment data, the potential impact on the computing device associated with performing the one or more tasks, the processing device is further to:
determine an inability for the computing device to maintain a quality of service (QoS) associated with a particular service according to a predefined threshold; and
determine to deny the computing device from performing the one or more tasks.

18. The system of claim 11, wherein to deny the computing device to perform the one or more tasks, the processing device is further to:
identify, based on the environment data, a first time period in which the potential impact on the computing device is above a predefined threshold value;
identify, based on the environment data, a second time period in which the potential impact on the computing device is below the predefined threshold value;
deny the computing device to perform the one or more tasks during the first time period; and
allow the computing device to perform the one or more tasks during the second time period.

19. The system of claim 11, wherein the processing device is further to:
identify, based on the environment data, a time period during which the computing device is powered by a plug-in power supply; and
instruct the computing device to perform a second task during the time period.

20. A non-transitory computer-readable medium storing instructions that, when execute by a processing device, cause the processing device to:
receive a request to perform one or more tasks on a computing device;
acquiring environment data associated with a computing environment of the computing device;
determine, based on the environment data, a potential impact on the computing device associated with performing the one or more tasks; and
allow or deny the computing device to perform the one or more tasks in response to determining the potential impact on the computing device associated with performing the one or more tasks.
